(19) United States
(12) Patent Application Publication
(10) Pub. No.: US 2007/0281571 A1
(43) Pub. Date: Dec. 6, 2007

(54) Control method for pre-warning an aging electric discharge lamp

(75) Inventor: Ying-Chang Cheng, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/443,215

(22) Filed: May 31, 2006

(51) Int. Cl. H01J 9/44

(52) U.S. Cl. 445/6

(57) ABSTRACT

A control method for pre-warning an aging electric discharge lamp includes the steps of determining a performance parameter of an electric discharge lamp, inputting the performance parameter into an arithmetic logic unit as a standard value of the electric discharge lamp, using a detector to detect an operating performance parameter of the electric discharge lamp, and comparing a performance parameter with the operating performance parameter by the arithmetic logic unit, and if the operating performance parameter matches an aging state of the performance parameter set in the arithmetic logic unit, then the arithmetic logic unit will output an aging signal of the electric discharge lamp as a warning, and thus users can change the aging electric discharge lamp before the electric discharge lamp breaks down.

### FIELD OF THE INVENTION

The present invention relates to a control method of an electric discharge lamp, and more particularly to a control method that can detect an aging state of an electric discharge lamp and provide a pre-warning function.

### BACKGROUND OF THE INVENTION

In recent years, portable electronic products and communication related industries are blooming, and thus the growth of liquid crystal display devices is increased substantially. In addition to the light, thin, short and compact requirements for the products of this sort, another important factor must be taken into consideration for the design of a simple structure of portable electronic products, not only providing a convenient manufacturing process, but also saving costs. In general, a backlight unit (BLU) generally refers to a unit that provides a backlight module to the product, and one of the typical applications is to provide a light source for this type of flat panel devices. There are four main types of light emitting components: an electron luminescence (EL), a hot cathode electron, a cold cathode fluorescent lamp (CCFL) and a light emitting diode (LED).

A gas discharge lamp is a small fluorescent electric discharge lamp used for LCD and such lamp is durable for frequent switching on and off. Such gas discharge lamp also has many advantages including low power consumption, high luminance, high efficiency, low heat production, long life, stable electric properties, good optical properties, and easiness of changing its stylish appearance, and thus the gas discharge lamps become a mainstream of lamp products. According to the light emission principle of such lamps, electric power is supplied to a fluorescent tube, and then a current is passed through electrodes to increase the temperature of an electron emitting matter, so as to discharge electrons to form an electron stream in the fluorescent tube and collide mercury atoms to produce an ultraviolet ray. The ultraviolet is projected onto a fluorescent matter coated onto the tube to produce visible light. Since the fluorescent lamp does not use any filament, therefore we do not have to worry about burning or breaking the filament, and we can have a reliable long-life lamp.

In view of the foregoing advantages, a liquid crystal display screen adopting an electric discharge lamp as its light source becomes a popular application for electric appliances (such as an LCD TV). In addition to the application of a liquid crystal display screen for general electric appliances, the liquid crystal display screen can be used extensively in the area of aviation and navigation such as a general civil aviation airplane, a military airplane or a submarine that requires a high precision of numeric values. If the electric discharge lamp used as a light source of the liquid crystal display screen in a dark condition and the lamp becomes aged or damaged, inestimable damages will result.

However, the aging and damage of an electric discharge lamp are inevitable and unpredictable. An estimated life expectancy of the electric discharge lamp may be given by manufacturers, and users may be able to change the electric discharge lamp before the lamp breaks down. However, such estimated life expectance is only an estimate, but it cannot provide an actual life of each electric discharge lamp at its operating environment. Individual electric discharge lamps have a shorter or longer life at a different operating environment, and thus users may change an electric discharge lamp long before the lamp breaks down, and thus wasting tremendous resources.

At present, there is no profound research conducted for this problem, and the criteria and timing for changing an electric discharge lamp applied in the area of aviation and navigation according to an estimated life expectancy should be provided in a much safer manner without wasting unnecessary resources.

### SUMMARY OF THE INVENTION

The primary objective of the present invention is to overcome the foregoing shortcomings and avoid the existing deficiencies by providing a control method for pre-warning an aging electric discharge lamp. The method comprises the steps of: determining a performance parameter of an electric discharge lamp; inputting the performance parameter into an arithmetic logic unit as a standard aging value of the electric discharge lamp; detecting an operating performance parameter of the electric discharge lamp by a detector while feeding back the operating performance parameter to the arithmetic logic unit; and comparing the values of the two parameters by the arithmetic logic unit, such that if the operating performance parameter matches the aging state set in the arithmetic logic unit, the arithmetic logic unit will output an aging signal of the electric discharge lamp as a warning, and thus users can change the aging electric discharge lamp before the electric discharge lamp breaks down.

### BRIEF DESCRIPTION OF THE DRAWINGS

FIG. 1 is a schematic waveform diagram of an operating status of an electric discharge lamp of the present invention;

FIG. 2 is a flow chart of a control of the present invention;

FIG. 3 is a schematic view of a preferred embodiment of the present invention; and

FIG. 4 is a schematic view of another preferred embodiment of the present invention.

### DETAILED DESCRIPTION OF THE PREFERRED EMBODIMENTS

The present invention will now be described in more detail hereinafter with reference to the accompanying drawings as follows:

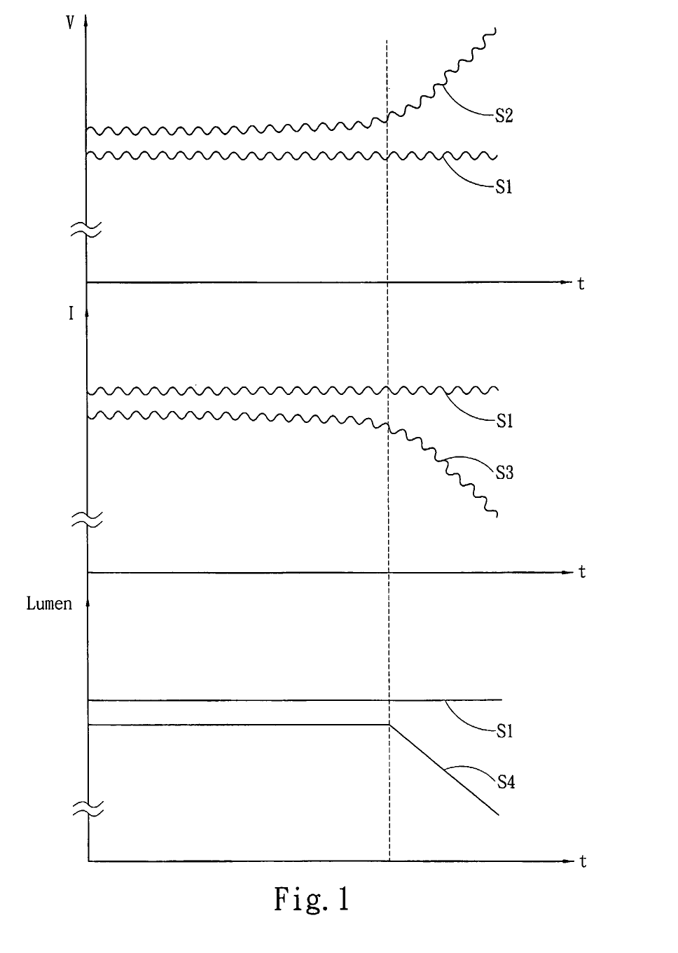

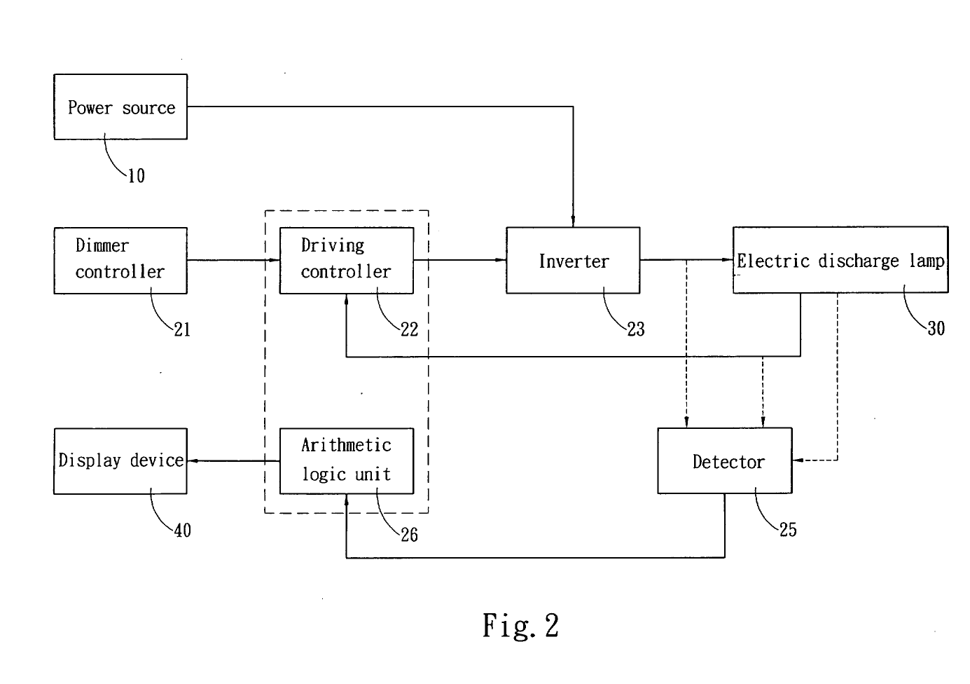

The present invention provides a control method for pre-warning an aging electric discharge lamp that can produce a pre-warning signal when the electric discharge lamp is aged, so that users can change the lamp before the electric discharge lamp breaks down. Referring to FIGS. 1 and 2 for the schematic waveform diagram of an operating state of the electric discharge lamp and the flow chart of a control according to the present invention respectively, the control method for pre-warning an aging electric discharge lamp 30 of the invention comprises the steps of determining a normal performance parameter S1 of the electric discharge lamp 30; building the normal performance parameter S1 in an arithmetic logic unit 26, and the normal performance parameter S1 could be an operating power parameter of the electric discharge lamp 30, wherein the power parameter could be a voltage V, a current I, or a lumen of the electric discharge lamp 30 as the normal performance parameter S1, and using a detector 25 to turn on the electric discharge lamp 30 and obtain an operating performance parameter S2, S3, S4 (and only one operating performance parameter S2, S3, S4 is selected). In FIG. 1, the operating performance parameter S2, S3 is a voltage V, a current I or a lumen of the electric discharge lamp 30, and the operating performance parameter S4 before the electric discharge lamp is aged and the time t are considered as having a stable horizontal parallel relation. If the operating performance parameter S2, S3 adopts a voltage V or a current I as its power parameter, and the electric discharge lamp 30 is aged, the electric resistance in the electric discharge lamp 30 will be increased greatly and the detector 25 will detect a change of voltage V and current I of the electric discharge lamp 30, and the detector 25 will feed back the change of the operating performance parameters S2, S3, S4 to the arithmetic logic unit 26 for comparing with the normal performance parameter S1. If the normal performance parameter S1 and the operating performance parameter S2, S3, S4 are not equal, it indicates that the electric discharge lamp 30 has entered into an aging state, and thus an aging signal of the electric discharge lamp 30 will be outputted, and the aging signal will be shown on a display device 40, so that users can receive the aging message of the electric discharge lamp 30.

Referring to FIG. 2 for the flow chart of the present invention, an electric power is supplied to an inverter 23 by a power source 10 to turn on an electric discharge lamp 30. The inverter 23 of the invention is controlled by a driving controller 22 to input a voltage V of the electric discharge lamp 30, and then a dimmer controller 21 is used to control the driving controller 22 to determine the lumen of the electric discharge lamp 30, and the driving controller 22 and the arithmetic logic unit 26 can be integrated into a microcontroller.

The normal performance parameter S1 of the electric discharge lamp 30 is set in an arithmetic logic unit 26 first, and the detector 25 receives operating performance parameters S2, S3, S4 inputted from the inverter 23 into the electric discharge lamp 30 and outputted by the electric discharge lamp 30. The arithmetic logic unit 26 compares the normal performance parameter S1 and the operating performance parameters S2, S3, S4. If the two performance parameters are not equal, then the arithmetic logic unit 26 will produce an aging signal of the electric discharge lamp 30 on a display device 40.

If the foregoing normal performance parameter S1 adopts the lumen as a reference value of the arithmetic logic unit 26, and the dimmer controller 21 controls the lumen of the electric discharge lamp 30, the intensity of lumen will vary the aging extent and speed of the electric discharge lamp 30, and thus the normal performance parameter S1 inputted to the arithmetic logic unit 26 still needs to refer to the dimming parameter adopted by the dimmer controller 21. The dimming parameter of the invention determines different normal performance parameters S1 to accurately obtain the point of timing t for the aging of the electric discharge lamp 30 and provide users a pre-warning signal.

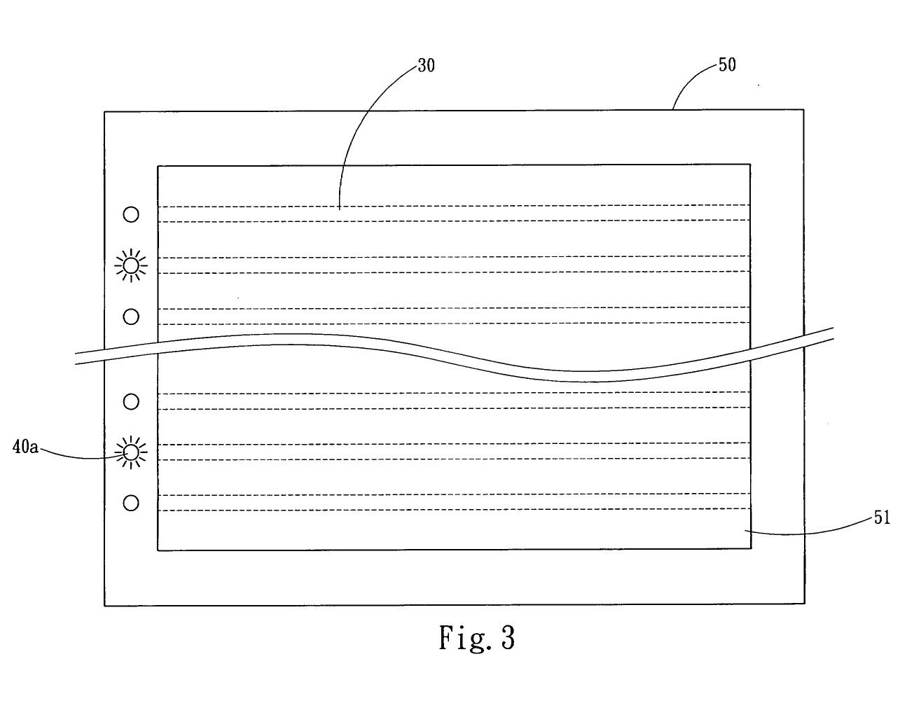

When the present invention generates a pre-warning signal to users, the following embodiment can be used for letting users know about the pre-warning signal of the aging of the electric discharge lamp 30. Referring to FIG. 3 for the schematic view of showing the pre-warning signal according to a preferred embodiment of the present invention, a display screen 50 adopts a control method of pre-warning an aging electric discharge lamp 30 of the invention (or a display screen 50 that adopts an electric discharge lamp 30 as the radiating light source), and a display device 40a for generating an aging signal of the electric discharge lamp 30 can be installed at the frame of the display screen 50, and the display device 40a is a lamp set, and each electric discharge lamp 30 has a corresponding light bulb, and thus the display device 40a can receive the aging signal of the electric discharge lamp 30 to produce light, when the electric discharge lamp 30 is aged, so that users can know that the electric discharge lamp 30 of the display device 40a is aged.

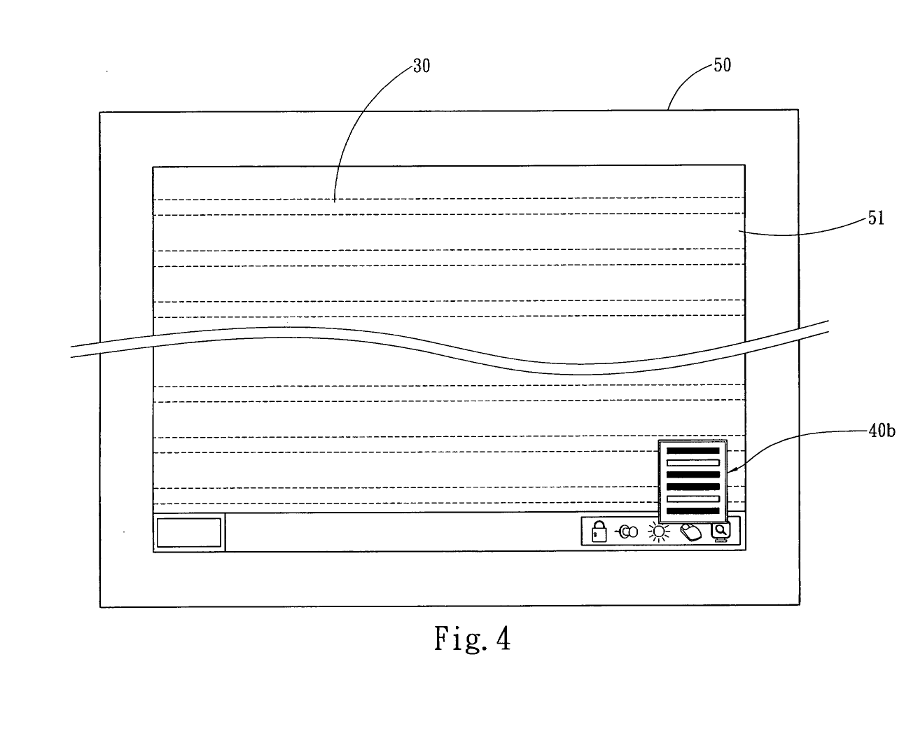

Referring to FIG. 4 for another preferred embodiment of the present invention, a display device 40b is installed at a display panel 51 on the display screen 50, wherein after the display device 40b is digitized, a status field of an aging state of the electric discharge lamp 30 is displayed on the display panel 51. If the status field shows a pre-warning signal for an aging of the electric discharge lamp 30, users can change the aged electric discharge lamp 30 according to the information given by the status field.

In the arithmetic logic unit 26, the performance parameter serving as a basic value for an aging of the electric discharge lamp 30 can be set as an aging performance parameter. If the operating performance parameter S2, S3, S4 detected by the detector 25 is equal to the aging performance parameter, then an aging signal of the electric discharge lamp 30 will be outputted. Further, the arithmetic logic unit 26 also can set the normal performance parameter S1 and the aging performance parameter of the electric discharge lamp 30, such that if the electric discharge lamp 30 has not produced an aging state yet, its operating performance parameter S2, S3, S4 will be equal to the normal performance parameter S1, and the arithmetic logic unit 26 will output a normal signal of the electric discharge lamp 30 to the display device 40b, and the display device 40b will display the normal state to indicate that the electric discharge lamp 30 is normal. If the operating performance parameter S2, S3, S4 is equal to the aging performance parameter, then the arithmetic logic unit 26 will output an aging signal of the electric discharge lamp 30 to the display device 40b and show a message for indicating the aging phenomenon of the electric discharge lamp 30.

While the invention has been described by means of specific embodiments, numerous modifications and variations could be made thereto by those skilled in the art without departing from the scope and spirit of the invention set forth in the claims.

What is claimed is:

1. A control method for pre-warning an aging electric discharge lamp, comprising the steps of:
determining a normal performance parameter of an electric discharge lamp, and building said normal performance parameter in an arithmetic logic unit;
turning on said electric discharge lamp, and using a detector to obtain an operating performance parameter of said electric discharge lamp;
inputting said operating performance parameter into said arithmetic logic unit, such that if said operating performance parameter is not equal to said normal performance parameter, then an aging signal of said electric discharge lamp will be outputted; and
receiving said aging signal of said electric discharge lamp by a display device and showing an aging pre-warning message of said electric discharge lamp.

2. The control method for pre-warning an aging electric discharge lamp of claim 1, wherein said parameter is a power parameter including a voltage or a current for the operation of said electric discharge lamp.

3. The control method for pre-warning an aging electric discharge lamp of claim 1, wherein said parameter is a lumen parameter for the operation of said electric discharge lamp.

4. The control method for pre-warning an aging electric discharge lamp of claim 1, wherein said electric discharge lamp determines a lumen by a dimming parameter, and a different performance parameter determines a different dimming parameter.

5. The control method for pre-warning an aging electric discharge lamp of claim 1, wherein said arithmetic logic unit and said driving controller for driving the operation of said electric discharge lamp are integrated into a microcontroller.

6. The control method for pre-warning an aging electric discharge lamp of claim 1, wherein said display device is built in a display screen disposed at a front end of a radiating light source of said electric discharge lamp.

7. The control method for pre-warning an aging electric discharge lamp of claim 6, wherein said display device is a lamp set disposed at a frame of said display screen or a display panel disposed on said display screen.

8. A control method for pre-warning an aging electric discharge lamp, comprising the steps of:
determining an aging performance parameter of an electric discharge lamp, and building said aging performance parameter into an arithmetic logic unit;
turning on said electric discharge lamp, and using a detector to obtain an operating performance parameter of said electric discharge lamp;
inputting said operating performance parameter into said arithmetic logic unit, such that if said operating performance parameter is equal to said aging performance parameter, an aging signal of said electric discharge lamp will be outputted; and
receiving said aging signal of said electric discharge lamp by a display device and showing an aging pre-warning message of said electric discharge lamp.

9. The control method for pre-warning an aging electric discharge lamp of claim 8, wherein said parameter is a power parameter including a voltage or a current for the operation of said electric discharge lamp.

10. The control method for pre-warning an aging electric discharge lamp of claim 8, wherein said parameter is a lumen parameter for the operation of said electric discharge lamp.

11. The control method for pre-warning an aging electric discharge lamp of claim 8, wherein said electric discharge lamp determines a lumen by a dimming parameter, and a different dimming parameter determines a different performance parameter.

12. The control method for pre-warning an aging electric discharge lamp of claim 8, wherein said arithmetic logic unit and said driving controller for driving said electric discharge lamp are integrated into a microcontroller.

13. The control method for pre-warning an aging electric discharge lamp of claim 8, wherein said display device is built in a display screen disposed at a front end of a radiating light source of said electric discharge lamp.

14. The control method for pre-warning an aging electric discharge lamp of claim 13, wherein said display device is a lamp set disposed at a frame of said display screen or a display panel disposed on said display screen.

15. A control method for pre-warning an aging electric discharge lamp, comprising the steps of:
determining a normal performance parameter of an electric discharge lamp, and building said normal performance parameter in an arithmetic logic unit;
determining an aging performance parameter of said electric discharge lamp and building said aging performance parameter in an arithmetic logic unit;
turning on said electric discharge lamp, and using a detector to obtain an operating performance parameter of said electric discharge lamp;
inputting said operating performance parameter into said arithmetic logic unit, such that if said operating performance parameter is equal to said normal performance parameter, then a normal signal of said electric discharge lamp will be outputted, and if said operating performance parameter is equal to said aging performance parameter, then an aging signal of said electric discharge lamp will be outputted; and
receiving said normal signal of said electric discharge lamp and said aging signal of said electric discharge lamp by a display device and showing a present operating state message of said electric discharge lamp.

16. The control method for pre-warning an aging electric discharge lamp of claim 15, wherein said parameter is a power parameter including a voltage or a current for the operation of said electric discharge lamp.

17. The control method for pre-warning an aging electric discharge lamp of claim 15, wherein said parameter is a lumen parameter for the operation of said electric discharge lamp.

18. The control method for pre-warning an aging electric discharge lamp of claim 15, wherein said electric discharge lamp determines a lumen by a dimming parameter and a different dimming parameter determines a different performance parameter.

19. The control method for pre-warning an aging electric discharge lamp of claim 15, wherein said arithmetic logic unit and said driving controller for driving the operation of said electric discharge lamp are integrated into a microcontroller.

20. The control method for pre-warning an aging electric discharge lamp of claim 15, wherein said display device is built in a display screen disposed at a front end of a radiating light source of said electric discharge lamp.

21. The control method for pre-warning an aging electric discharge lamp of claim 20, wherein said display device is a lamp set disposed at a frame of said display screen or a display panel disposed on said display screen.
